(19) United States
(12) Patent Application Publication
(10) Pub. No.: US 2018/0097944 A1
(43) Pub. Date: Apr. 5, 2018

(54) INFORMATION PROCESSING APPARATUS

(71) Applicant: FUJI XEROX CO., LTD., Tokyo (JP)

(72) Inventors: Shin OTAKE, Kanagawa (JP); Fumihisa SUZUKI, Kanagawa (JP); Naoya KONITA, Kanagawa (JP)

(73) Assignee: FUJI XEROX CO., LTD., Tokyo (JP)

(21) Appl. No.: 15/721,746

(22) Filed: Sep. 30, 2017

(30) Foreign Application Priority Data
Oct. 3, 2016 (JP) 2016-195812

(51) Int. Cl. H04N 1/00; G06F 3/12

(52) U.S. Cl. CPC H04N 1/00222; H04N 1/00005; H04N 2201/0094; G06F 3/1203; G06F 3/1285

(57) ABSTRACT

An information processing apparatus includes a first acquisition unit acquiring a user list, a group list, and an authority list, a second acquisition unit acquiring method data indicating a method of determining, with respect to a target user, a group to which the user belongs from the group list and an authority applied to the group from the authority list, a reception unit that receives a request for a process from a user, transmitted from a terminal, a third acquisition unit acquiring transmission source data including information regarding the user or the terminal, a determination unit determining a group to which the user making the request belongs and an authority applied to the group from the lists according to a method indicated by the method data, and a generation unit generating authority data in which the user making the request is correlated with the determined authority.

### CROSS-REFERENCE TO RELATED APPLICATIONS

This application is based on and claims priority under 35 USC 119 from Japanese Patent Application No. 2016-195812 filed Oct. 3, 2016.

### BACKGROUND

### Technical Field

The present invention relates to an information processing apparatus.

### SUMMARY

According to an aspect of the invention, there is provided an information processing apparatus including a first acquisition unit that acquires a list of users, a list of plural groups to which the users belong, and a list of plural authorities defining whether or not a process is possible; a second acquisition unit that acquires method data indicating a method of determining, with respect to a target user, a group to which the user belongs among the plural groups and an authority applied to the group among the plural authorities on the basis of associated information regarding the user; a reception unit that receives a request for a process from a user, transmitted from a terminal; a third acquisition unit that acquires transmission source data including information regarding the user or the terminal which is a transmission source of the request; a determination unit that determines a group to which the user making the request belongs and an authority applied to the group among plural of groups and plural authorities indicated by the acquired lists according to a method indicated by the acquired method data by using information included in the acquired transmission source data as the associated information; and a generation unit that generates authority data in which the user making the request for a process is correlated with the determined authority.

### BRIEF DESCRIPTION OF THE DRAWINGS

Exemplary embodiment(s) of the present invention will be described in detail based on the following figures, wherein:

FIG. 1 is a diagram illustrating the entire configuration of an information processing system;

FIG. 2 is a diagram illustrating a hardware configuration of a user terminal;

FIG. 3 is a diagram illustrating a hardware configuration of an operation terminal;

FIG. 4 is a diagram illustrating a hardware configuration of an information processing apparatus;

FIG. 5 is a diagram illustrating a hierarchical structure of a function of the information processing system;

FIG. 6 is a diagram illustrating details of a functional configuration of the information processing system;

FIG. 7 is a diagram illustrating an example of a module group included in a functional unit;

FIG. 8 is a diagram illustrating an example of session data;

FIG. 9 is a diagram illustrating an example of session data;

FIG. 10 is a diagram illustrating an example of a user list;

FIG. 11 is a diagram illustrating an example of a group list;

FIG. 12 is a diagram illustrating an example of an authority list;

FIG. 13 is a diagram illustrating an example of determination method data;

FIG. 14 is a diagram illustrating an example of generated authority data;

FIG. 15 is a diagram illustrating an example of a displayed group setting screen;

FIG. 16 is a diagram illustrating an example of a displayed authority setting screen;

FIG. 17 is a diagram illustrating an example of an operation procedure of the information processing system;

FIG. 18 is a diagram illustrating an example of a displayed home screen;

FIG. 19 is a diagram illustrating an example of an operation procedure of the information processing system;

FIG. 20 is a diagram illustrating an example of determination method data in a modification example; and

FIGS. 21A to 21C are diagrams illustrating an example of determination method data in modification examples.

### DETAILED DESCRIPTION

### 1. Example

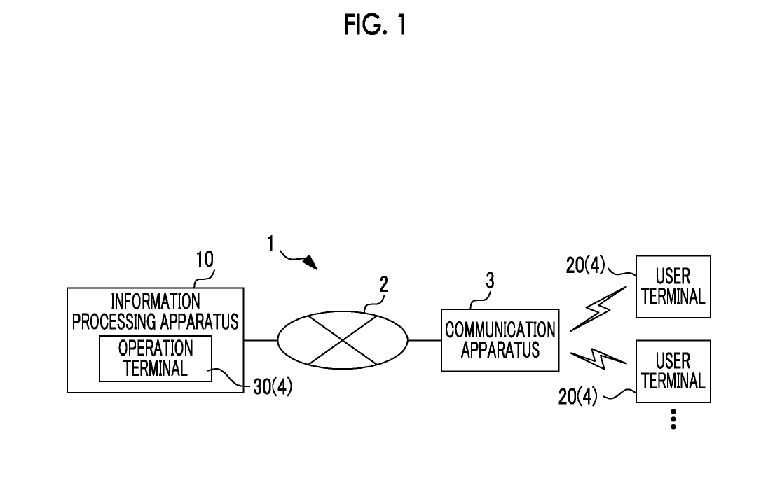

FIG. 1 illustrates the entire configuration of an information processing system 1. The information processing system 1 includes a communication line 2, a communication apparatus 3, an information processing apparatus 10, and plural user terminals 20. In the present example, the information processing system 1 provides functions such as copying, scanning, facsimile (FAX), and printing (outputting image data to a medium) to a user.

The communication line 2 includes, for example, the Internet, a mobile communication network, and a telephone line, and relays communication among apparatuses connected to the line. The communication line 2 is connected to the information processing apparatus 10 and the communication apparatus 3. The communication apparatus 3 has an apparatus having a communication function, and performs wireless communication on the basis of the standard of a wireless local area network (LAN) in the present example. The communication apparatus 3 performs wireless communication with the user terminals 20, and also performs communication with the information processing apparatus 10 via the communication line 2. In other words, the information processing apparatus 10 performs communication with the user terminals 20 via the communication line 2 and the communication apparatus 3.

The information processing apparatus 10 performs processes such as an image forming process of forming an image on a medium or an image reading process of reading an image formed on a medium. This process is performed when the above-described functions such as copying, scanning, FAX, and printing are provided to a user. The information processing apparatus 10 includes an operation terminal 30 used to operate the information processing apparatus 10. The operation terminal 30 is one of terminals (hereinafter, referred to as user interface (UI) terminals used as user interfaces of the information processing apparatus 10).

A user interface is an interface for a user exchanging information with an operation target apparatus (the information processing apparatus 10 in the present example). The user operates the operation target apparatus via the UI terminal. The UI terminal displays a screen used for the user to perform an operation, or a screen (for example, a screen displaying a result of the operation) corresponding to the operation. The operation terminal 30 is fixed to a casing of the information processing apparatus 10, and is used by a user visiting a location where the information processing apparatus 10 is provided.

Each of the user terminals 20 is a terminal used by a user, and is, for example, a. smart phone, a tablet terminal, or a personal computer. The user terminal 20 performs communication with the information processing apparatus 10 so as to exchange data for operating the information processing apparatus 10. The user terminal 20 is one of UI terminals of the information processing apparatus 10. As mentioned above, the user terminal 20 and the operation terminal 30 are all UI terminals of the information processing apparatus 10, and will be hereinafter referred to as a UI terminal 4 in a case of not being differentiated from each other.

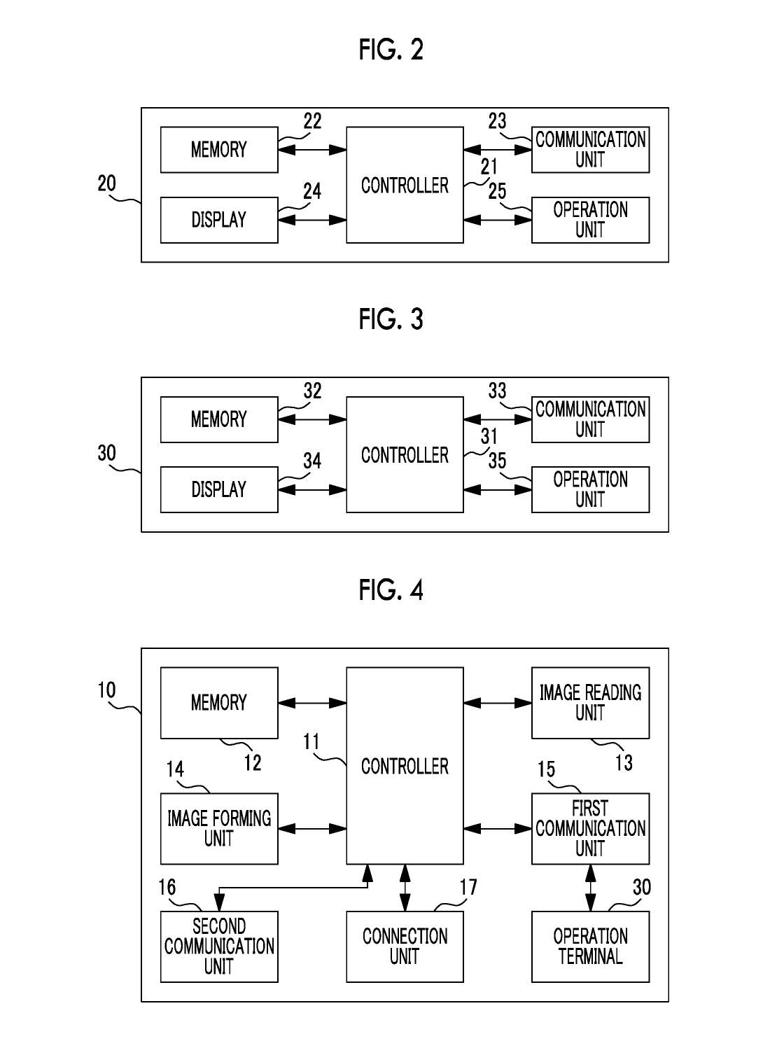

FIG. 2 illustrates a hardware configuration of the user terminal 20. The user terminal 20 is a computer including a controller 21, a memory 22, a communication unit 23, a display 24, and an operation unit 25. The controller 21 includes a central processing unit (CPU), a read only memory (ROM), a random access memory (RAM), and a real-time clock, and controls an operation of each unit by the CPU executing a program stored in the ROM or the memory 22 by using the RAM as a work area. The real-time clock calculates the current date and time, and notifies the CPU of the calculated date and time. The memory 22 includes, for example, a flash memory, and stores data or a program (for example, a web application such as a browser) used for control in the controller 21, or image data.

The communication unit 23 includes a communication circuit and an antenna performing wireless communication on the basis of the standard of a wireless LAN, and performs wireless communication with, for example, the communication apparatus 3 illustrated in FIG. 1. The display 24 includes, for example, a liquid crystal display, and displays an image on a display surface under the control of the controller 21. For example, in a case where the user terminal is a smart phone or a tablet terminal, the operation unit 25 includes a touch sensor (also referred to as a touch screen or a touch panel) provided to overlap the display surface, or buttons provided on a casing thereof, and receives a user's operation such as tapping so as to supply operation data indicating the content of the operation to the controller 21. In a case where the user terminal is a personal computer, the operation unit 25 may include a keyboard or a mouse. The controller 21 performs control corresponding to the supplied operation data.

FIG. 3 illustrates a hardware configuration of the operation terminal 30. The operation terminal 30 is a computer including a controller 31, a memory 32, a communication unit 33, a display 34, and an operation unit 35. The respective units other than the communication unit 33 are hardware common to the respective units having the same names in FIG. 2. The communication unit 33 includes a communication circuit performing communication on the basis of the standard of a wired LAN, and a port into which a connector of a communication cable (specifically, a LAN cable) is inserted.

FIG. 4 illustrates a hardware configuration of the information processing apparatus 10. The information processing apparatus 10 is a computer including a controller 11, a memory 12, an image reading unit 13, an image forming unit 14, a first communication unit 15, a second communication unit 16, and a connection unit 17. The information processing apparatus 10 includes the above-described operation terminal 30 which functions as a user interface (UI). The controller 11 controls respective units other than the operation terminal 30. The controller 11 is hardware common to the controller 21 in FIG. 2. The memory 12 includes, for example, a hard disk, and stores data or a program used for control in the controller 11, or image data.

The image reading unit 13 performs an image reading process of reading an image drawn on an original document by using, for example, a charge coupled device (CCD) method. The image reading unit 13 optically reads an image of the content formed on a medium such as paper, and supplies image data indicating the read image to the controller 11. The image forming unit 14 performs an image forming process of forming an image on a medium by using, for example, an electrophotographic method. The image forming unit 14 forms an image indicated by image data supplied from the controller 11 on a medium such as paper. Each of the above-described methods used to read an image and to form an image is only an example, and other methods may be used. The first communication unit 15 is connected to the communication unit 33 of the operation terminal 30 via a communication cable or a data bus, and performs communication with the operation terminal 30 without using the above-described external apparatus. In other words, the communication unit 33 also performs communication with the information processing apparatus 10 without using the external apparatus.

The second communication unit 16 includes a communication circuit performing communication on the basis of the standard of a wired LAN or a wireless LAN as a communication interface, and a port into which a connector of a communication cable (LAN cable) is inserted, or a wireless transmission/reception device based on the standard of a wireless LAN, and performs a communication process of performing communication with a device which is connected thereto via the interface. The second communication unit 16 is connected to the communication line 2 illustrated in FIG. 1, and performs communication with, for example, the user terminal 20 via an external apparatus (which is an external apparatus of the information processing apparatus 10, and is, for example, the communication apparatus 3). The connection unit 17 has a slot or the like for connection of a storage medium such as an SD memory card, and is connected to such a storage medium. The controller 11 reads data stored on the storage medium or writes data in the storage medium via the connection unit 17. The operation terminal 30 includes the configuration described in FIG. 3, and performs communication with the first communication unit 15.

Each of the controllers of the information processing apparatus 10, the user terminal 20, and the operation terminal 30 controls each unit by executing the program, and thus the following functions are realized.

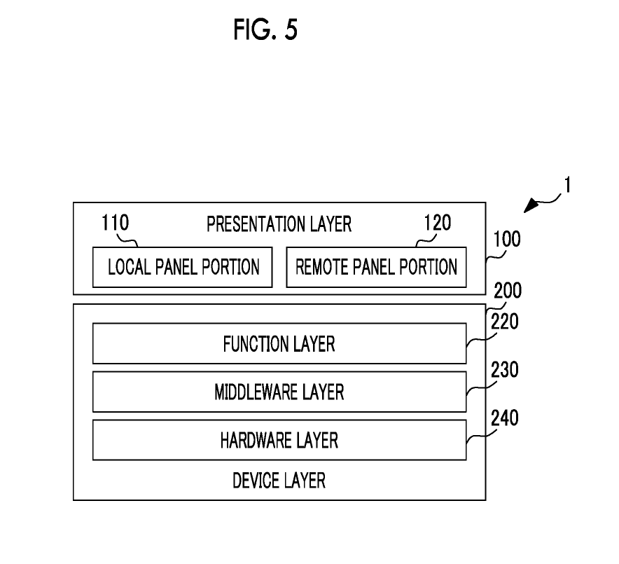

FIG. 5 illustrates a hierarchical structure of a function of the information processing system 1. The information processing system 1 includes a presentation layer 100 and a device layer 200. The presentation layer 100 is a layer which realizes a function (user interface) of receiving an operation performed by a user. The device layer 200 is a layer which performs a process in response to the user's operation received by the presentation layer 100 so as to provide the above-described various functions such as copying or scanning.

The presentation layer 100 includes a local panel portion 110 and a remote panel portion 120. The local panel portion 110 is an operation panel provided in the information processing apparatus 10, and is used by a user visiting a location (local) where the information processing apparatus 10 is provided. The remote panel portion 120 is an operation panel connected to the information processing apparatus 10 via the communication line 2 and the communication apparatus 3 illustrated in FIG. 1, and is used by a user located at a location (remote) separated from the information processing apparatus 10.

The device layer 200 includes a function layer 220, a middleware layer 230, and a hardware layer 240. The function layer 220 is a layer which realizes a function of processing data depending on a purpose of use, such as a copying function or a scanning function. The middleware layer 230 is a layer which realizes a general purpose process on the basis of a user's operation in the middle of the function layer 220 and the hardware layer 240. The hardware layer 240 is a layer which physically realizes a process such as image reading or image formation.

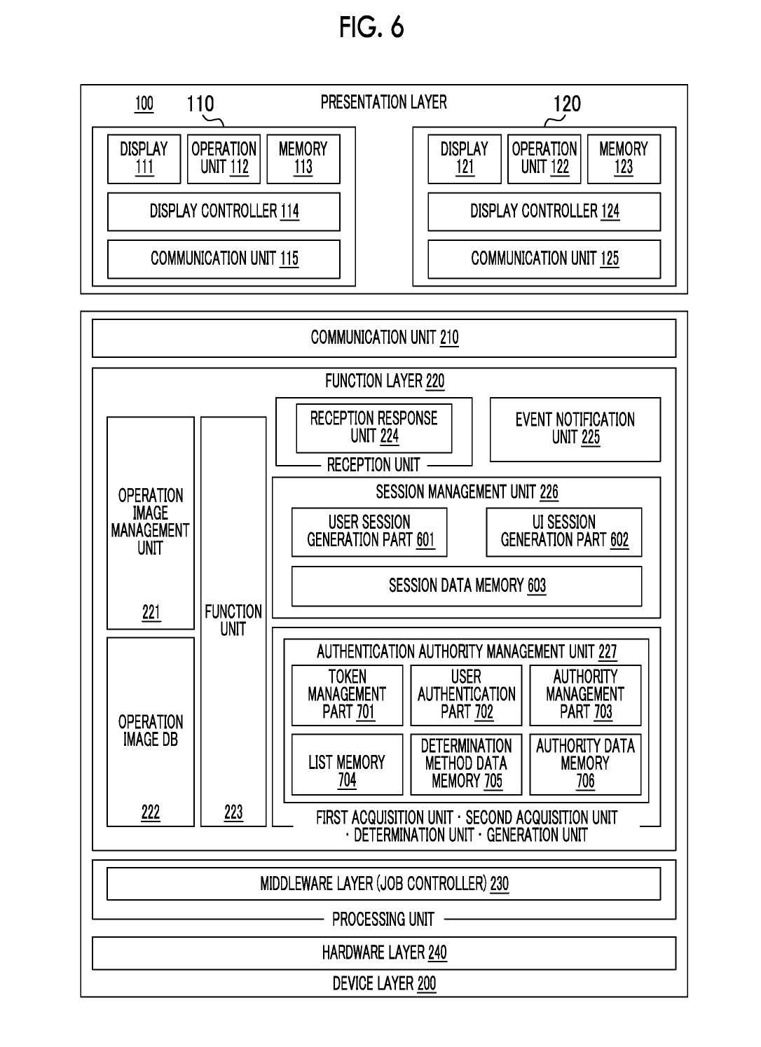

FIG. 6 illustrates details of a functional configuration of the information processing system 1. The local panel portion 110 includes a display 111, an operation unit 112, a memory 113, a display controller 114, and a communication unit 115. The display 111 displays an image. The operation unit 112 receives a user's operation. The memory 113 stores an image to be displayed.

The display controller 114 controls the display 111 to display an image (hereinafter, referred to as an “operation image”) for operating the information processing apparatus 10, or information indicating a situation of a process performed according to the operation. The communication unit 115 controls communication with device layer 200 performed by the display controller 114. The remote panel portion 120 includes a display 121, an operation unit 122, a memory 123, a display controller 124, and a communication unit 125. The respective units have functions common to the functions of the same units of the local panel portion 110.

The device layer 200 includes a communication unit 210. The communication unit 210 relays communication between a master apparatus (information processing apparatus 10) and the presentation layer 100. The communication unit 210 relays communication on the basis of the standard of the Hypertext Transfer Protocol (HTTP; for example, defined in RFC7230)/the Hypertext Transfer Protocol Secure (HTTPS). The communication unit 210 relays communication of data (hereinafter, referred to as “XML data”) described in, for example, the Extendable Markup language (XML) on the basis of the standard of the Simple Object Access Protocol (SOAP). For example, the communication unit 210 receives XML data indicating an HTTP request transmitted from the presentation layer 100 so as to supply the XML data to an operation image management unit 221 which will be described later, and receives XML data indicating an HTTP response supplied from the operation image management unit 221 which will be described later in response thereto so as to transmit the XML data to the presentation layer 100.

The communication unit 210 is also based on the standard of WebSocket (for example, defined in RFC6455). The communication unit 210 relays not only communication of XML data indicating an HTTP request and an HTTP response after the presentation layer 100 is temporarily connected through a handshake procedure of the Transmission Control Protocol (TCP), but also transmission of XML data to the presentation layer 100 performed at any timing from, for example, an event notification unit 225, on the basis of this standard. Consequently, the information processing system 1 performs not only so-called pull type communication (synchronous communication) based on an HTTP request transmitted from the presentation layer 100 but push type communication (asynchronous communication) based on an HTTP request transmitted from the information processing apparatus 10.

The function layer 220 includes the operation image management unit 221, an operation image database (DB) 222, a function unit 223, a reception response unit 224, the event notification unit 225, a session management unit 226, and an authentication authority management unit 227. The operation image management unit 221 provides the above-described operation image (the image for operating the information processing apparatus 10) to the UI terminal 4 via the communication unit 210. The operation image DB 222 stores operation images (specifically, image data indicating the operation images). If a request for an operation image is made by the UI terminal 4, the operation image management unit 221 transmits the operation image for which the request has been made to the UI terminal 4 which is a request source via the communication unit 210.

The function unit 223 is a module group for realizing a function provided to a user by the information processing apparatus 10.

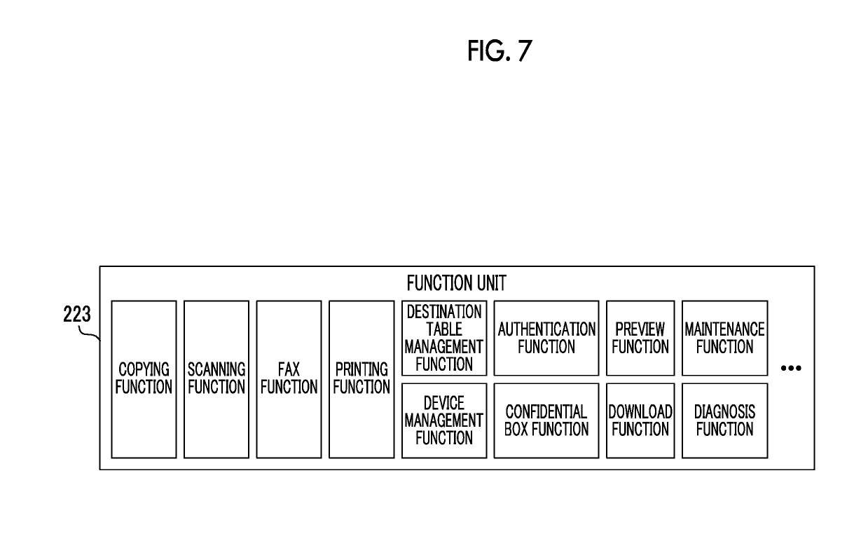

FIG. 7 illustrates an example of a module group included in the function unit 223. The function unit 223 includes modules for respectively realizing a copying function, a scanning function, a FAX function, a printing function, a destination table management function (a function of managing destination information), a device management function (a function of managing an original document set state in the image reading unit 13 or a state of a medium or an expendable of the image forming unit 14), an authentication function, a confidential box function (a function of managing electronic documents stored in the information processing apparatus 10), a preview function, a download function (a function of controlling update of a program), a maintenance function (a function of performing maintenance on hardware in response to a request from the remote), and a diagnosis function (a hardware diagnosis function).

The function unit 223 performs a scanning process, a FAX transmission process, and a printing process (the processes for providing the scanning function, the FAX function, and the printing function) in addition to the above-described copying process. The copying process includes an image reading process performed by the image reading unit 13 and an image forming process performed by the image forming unit 14 illustrated in FIG. 4. The scanning process includes an image reading process, and the FAX transmission process includes a FAX communication process performed by the second communication unit 16. The printing process includes a communication process performed by the first communication unit 15, and an image forming process. The scanning process and the FAX transmission process also include a data communication process using the second communication unit 16, a writing process of writing data in the memory 12, and a reading process of reading stored data from the memory 12, according to data acquisition and output methods.

The function unit 223 receives an instruction for execution of a process from the middleware layer 230. If a process is performed, the function unit 223 supplies information indicating a situation of the performed process to the session management unit 226. The function unit 223 supplies a result of the performed process to the event notification unit 225 via the middleware layer 230.

The reception response unit 224 receives a request for a process sent from a user via the UI terminal 4 (the user terminal 20 and the operation terminal 30, in other words, the presentation layer 100). The reception response unit 224 is an example of a “reception unit” of an exemplary embodiment of the invention. If this request is received, the reception response unit 224 requests the function unit 223 to perform the process according to the type of received process.

The reception response unit 224 transmits response data (for example, data indicating that the request has been received, or data indicating a situation of the process) indicating a response to the received request to the presentation layer 100 via the communication unit 210. The event notification unit 225 notifies the presentation layer 100 of, for example, the information indicating a situation of the process, supplied from the function unit 223 via the middleware layer 230.

The session management unit 226 manages connection of the UI terminal 4, and an operation state and a processing state in the UI terminal 4. The session management unit 226 includes a user session generation part 601, an UI session generation part 602, and a session data memory 603. A session indicates a series of operations or communications until the UI terminal 4 is disconnected from the information processing apparatus 10 from connection thereto or until a user logouts from login, and is used as the unit for managing the series of operations or communications.

The session is formed of a user session and a UI session. The user session holds information indicating (hereinafter, referred to as “operation state information”) indicating a state of an operation performed by a user and a state of a process for which an instruction is given by the user. The operation state information includes, for example, situations in which a process is performed or a confidential box is viewed. The UI session holds information (hereinafter, referred to as communication management information) for managing communication with the user terminal 20 operated by a user. The communication management information includes information required to manage communication connection, such as IP addresses or types of programs (for example, a browser) executed in the user terminal 20.

The user session generation part 601 generates session data for each user logging into a master apparatus (information processing apparatus 10). The session data for each user is information (hereinafter, referred to as “user specifying information”) for specifying a user who logs in, and is, for example, a user identification (ID) used for login or text indicating a user name.

The UI session generation part 602 generates session data for each UI terminal 4 receiving an operation. The session data for each UI terminal 4 is information (hereinafter, referred to as “terminal specifying information”) for specifying the UI terminal 4, and is, for example, text (a “local panel portion” or “remote panel portion” in the present example) indicating whether the UI terminal 4 is the local panel portion 110 or the remote panel portion 120, and an Internet Protocol (IP) address of the UI terminal 4. For example, in a case where plural kinds of presentation applications (browsers) operate in the same information processing apparatus 10, a UI session is generated for each browser.

The session management unit 226 generates the above-described operation state information, and stores the operation state information in the session data memory 603 storing session data or the like, in correlation with session data of the user. The session management unit 226 stores, as the operation state information, information in which, for example, information (for example, text of a “menu screen”) for identifying an operation screen and information (for example, text of “scanning process selection”) for identifying an operation on the screen are correlated with each other. The session management unit 226 stores the generated user specifying information and terminal specifying information in the session data memory 603 in correlation with each other.

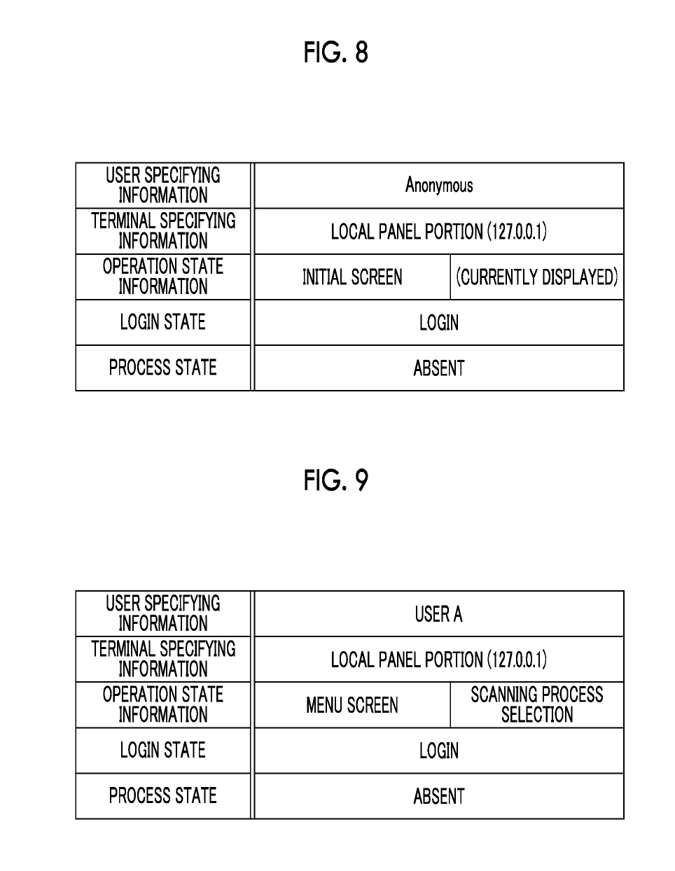

The session data memory 603 stores session data corresponding to a session state. A description will be made of changes in session data stored in the session data memory 603 with reference to FIGS. 8 and 9.

FIG. 8 illustrates an example of session data when the information processing apparatus 10 is activated. In the example illustrated in FIG. 8, user specifying information of “Anonymous”, terminal specifying information of “local panel portion (127.0.0.1)”, operation state information indicating that an “initial screen” is currently displayed, a login state indicating that “login” is currently performed, and a process state indicating that is a currently performed process is “absent” are correlated with each other.

“Anonymous” is a user name indicating a state in which no one logs in before an initial user logs in after the information processing apparatus 10 is activated, and, in this example, the user name is used as the user specifying information. The terminal specifying information is represented by the name (the local panel portion or the remote panel portion) of a UI terminal and the IP address. FIG. 9 illustrates an example of session data in a case where a user A performs a login operation in the state illustrated in FIG. 8.

In the example illustrated in FIG. 9, in the state illustrated in FIG. 8, the user specifying information changes to a user name of “user A”, and the operation state information changes from the “menu screen” to a screen indicating that an operation of “scanning process selection” has been performed. The left on the operation state information illustrates the name of a displayed screen, and the right thereon illustrates the content of an operation performed by a user on the screen.

The authentication authority management unit 227 manages authentication data used for authentication of a user, and authority data indicating authority defining whether or not a process desired to be performed by a user is possible. The authentication authority management unit 227 checks the authority of the user when the user logs in, or a process is performed, and authenticates the user operating the master apparatus, by using the authentication data and the authority data. The authentication authority management unit 227 includes a token management part 701, a user authentication part 702, an authority management part 703, a list memory 704, a determination method data memory 705, and an authority data memory 706.

The token management part 701 manages a token which is data for checking whether or not exchanged data during authentication is replaced on the way. If there is a request for login from the user, the token management part 701 generates a token correlated with a user ID used for the login. The generated token is included in request data generated when the user makes a request for a process along with the user ID. The token management part 701 examines whether or not the token included in the request data is correct, causes the next process to be performed if the token is correct, and detects the presence of illegality and notifies the user thereof if the token is not correct.

The user authentication part 702 determines whether or not the user made the request for login is a regular user, and authenticates the user if the user is a regular user. The user authentication part 702 is an example of an “authentication unit” of an exemplary embodiment of the invention. Specifically, the user authentication part 702 inquires of the authority management part 703 about whether or not the user has the authority for login, and authenticates the user in a case where the user has the authority.

The authority management part 703 manages authority of a user who requests a master apparatus to perform a process. The authority management part 703 manages authorities for processes such as a login process, a copying process, a scanning process, a FAX transmission process, and a printing process. For example, in the copying process, the authority management part 703 manages authorities such as unrestricted copying permission, only monochrome permission, only color permission, and monochrome/cheap color permission and copying prohibition. The authority management part 703 manages the authorities by acquiring data stored in the list memory 704 and the determination method data memory 705.

The list memory 704 stores three lists such as a user list, a group list, and an authority list. The user list is a list of users posting the above-described user specifying information. The group list is a list posting plural groups to which users belong. The authority list is a list describing the content of each of plural authorities defining whether or not processes are to be performed.

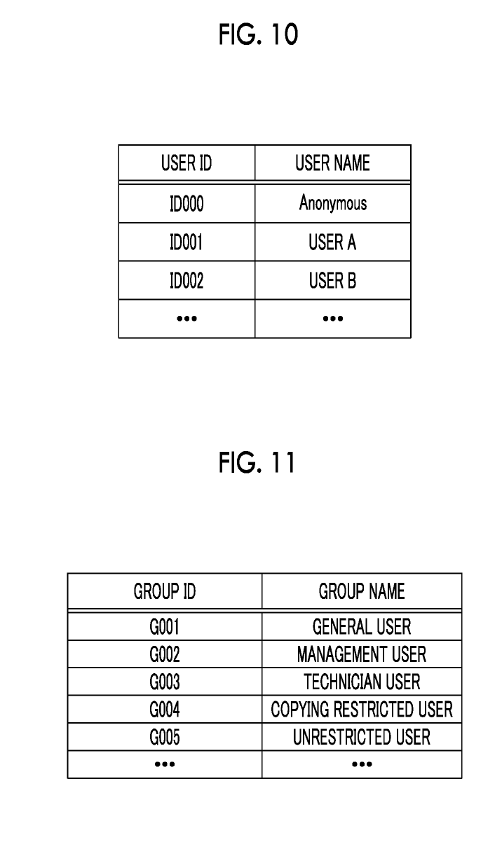

FIG. 10 illustrates an example of a user list. In the example illustrated in FIG. 10, the list memory 704 stores a user list in which user IDs such as “ID000”, “ID001”, and “ID002” are correlated with user names such as “Anonymous”, “user A”, and “user B”. In the present example, a user ID is allocated to “Anonymous” indicating a state in which no one logs in, in order to manage authority. The user list includes all users who use the information processing system 1 and are assigned with user IDs.

FIG. 11 illustrates an example of a group list. In the example illustrated in FIG. 11, the list memory 704 stores a group list in which group IDs such as “G001”, “G002”, “G003”, “G004”, and “G005” are correlated with respective group names such as “general user”, “management user”, “technician user”, “copying restricted user”, and “unrestricted user”. The group list includes all groups which are set by a person in charge operating and managing the information processing system 1 in addition to the illustrated groups.

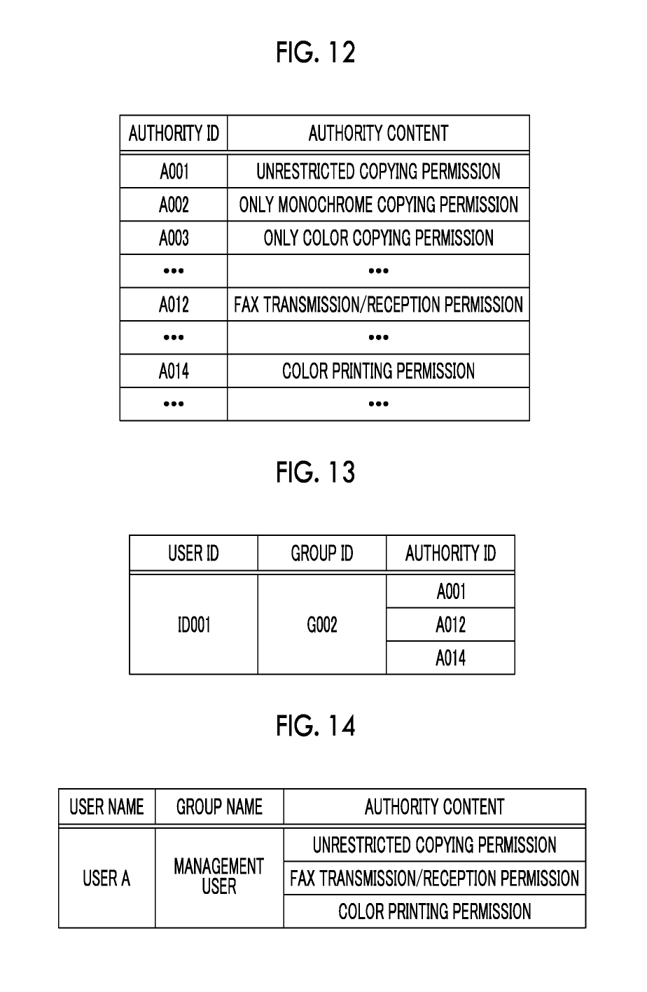

FIG. 12 illustrates an example of an authority list. In the example illustrated in FIG. 12, the list memory 704 stores an authority list in which authority IDs such as “A001”, “A002”, “A003”, “A012”, and “A014” are correlated with “unrestricted copying permission”, “only monochrome copying permission”, “only color copying permission”, “FAX transmission/reception permission”, and “color printing permission” respectively indicating the content of authorities. The authority list includes all authorities set by the above-described person in charge of operation and management in addition to the illustrated authorities.

The determination method data memory 705 stores determination method data. The determination method data is data indicating a method of determining an authority to be applied from among the plural authorities for each user. Specifically, the determination method data indicates a method of determining a group to which a target user belongs among plural groups and an authority applied to the group among plural authorities on the basis of associated information regarding the user with respect to the target user who is a target to which an authority to be applied is determined.

In the present example, in a case where a request for a process from a user is sent to the information processing apparatus 10 from the UI terminal 4, information regarding a transmission source of the request is used as associated information. The information regarding a transmission source is information regarding at least one of the user making the request and the UI terminal 4. In the present example, a user name included as user specifying information in the session data illustrated in FIGS. 8 and 9 is used as the information regarding a transmission source.

FIG. 13 illustrates an example of determination method data. In the example illustrated in FIG. 13, the determination method data memory 705 stores, as determination method data, a table in which a user ID of “ID001”, a group ID of “G002”, and authority IDs of “A001”, “A012”, and “A014” are correlated with each other. The determination method data indicates that, in a case where a user having a user ID of “ID001”, that is, the user A is a target user, the user A belongs to a management user group having a group ID of “G002”, and the management user has an authority (unrestricted copying permission) having an authority ID of “A001”, an authority (FAX transmission/reception permission) having an authority ID of “A012”, and an authority (color printing permission) having an authority ID of “A014”, permitted for the user.

If the reception response unit 224 receives the request for a process from the user, transmitted from the UI terminal 4 as described above, the authority management part 703 determines a group to which the user making the request for a process belongs, and an authority to be applied to the group. The authority management part 703 is an example of a “determination unit” of an exemplary embodiment of the invention. The authority management part 703 acquires the user list, the group list, and the authority list from the list memory 704 in order to perform the determination. The authority management part 703 in this case is an example of a “first acquisition unit” of an exemplary embodiment of the invention.

The authority management part 703 acquires the determination method data from the determination method data memory 705 in order to perform the determination. The authority management part 703 in this case is an example of a “second acquisition unit” of an exemplary embodiment of the invention. Specifically, the authority management part 703 refers to the determination method data memory 705 so as to acquire the determination method data in which the user making the request for a process is set as a target user.

The authority management part 703 acquires information regarding the above-described transmission source, that is, transmission source data including information regarding the user or the UI terminal 4 which is a transmission source of the request for a process. The authority management part 703 in this case is an example of a “third acquisition unit” of an exemplary embodiment of the invention. Ina case where the request for a process is received by the reception response unit 224, the authority management part 703 acquires the session data stored in the session data memory 603 as the transmission source data. The authority management part 703 performs the determination on the basis of the user list, the group list, the authority list, the determination method data, and the transmission source data acquired in the above-described way.

Specifically, the authority management part 703 determines a group to which the user making the request for a process belongs among plural groups indicated by the acquired group list in a method indicated by the determination method data in which the information regarding the transmission source included in the acquired transmission source data is acquired as associated information. The authority management part 703 determines an authority applied to the determined group among plural authorities indicated by the acquired authority list in the method indicated by the acquired determination method data.

For example, in a case where session data including the “user A” is acquired as the information regarding a transmission source, the authority management part 703 acquires the determination method data illustrated in FIG. 13, as determination method data including “ID001” which is a user ID assigned to the user A. In this case, the authority management part 703 determines a group to which the user A belongs as the “management user” assigned with a group ID of “G002” correlated with “ID001”, and determines authorities assigned with authority IDs of “A001”, “A012”, and “A014” correlated with “G002” as authorities to be applied to the group.

The authority management part 703 generates authority data in which the group, the authorities, and the user making the request for a process determined in the above-described way are correlated with each other. The authority management part 703 in this case is an example of a “generation unit” of an exemplary embodiment of the invention.

FIG. 14 illustrates an example of generated authority data. In the example illustrated in FIG. 14, the authority management part 703 generates, as authority data, a table in which a user name of “user A”, a group name of a “management user”, and the authority content of “unrestricted copying permission”, “FAX transmission/reception permission”, and “color printing permission” (the corresponding to authority IDs of “A001”, “A012”, and “A014”).

The authority management part 703 stores the generated authority data in the authority data memory 706. The middleware layer 230 performs a process responding to the request for the process from the user according to the authorities indicated by the authority data stored in the authority data memory 706, that is, the authority data generated by the authority management part 703. The middleware layer 230 is an example of a “processing unit” of an exemplary embodiment of the invention.

For example, in a case where the user A makes a request for a copying process, the middleware layer 230 reads, for example, the authority data illustrated in FIG. 14 as authority data including a user name of “user A” by referring to the authority data memory 706. As indicated by the read authority data, the authority content of “unrestricted copying permission” is applied to the user A, and thus the middleware layer 230 performs a copying process regardless of setting of a copying process for which a request is made.

On the other hand, for example, it is assumed that the user B belongs to a “general user”, and the authority of “only monochrome copying permission” is applied to the user B. In a case where the user B makes a request for a color copying process, the read authority data indicates the authority content of “only monochrome copying permission”, and, thus, for example, the middleware layer 230 performs a process of causing the UI terminal 4 to display a notification that color copying is not permitted.

The above-described determination method data is generated, for example, by a person in charge of operation and management of the information processing system 1 performing operations of setting a group and authority. The UI terminal 4 displays a setting screen for setting a group and authority.

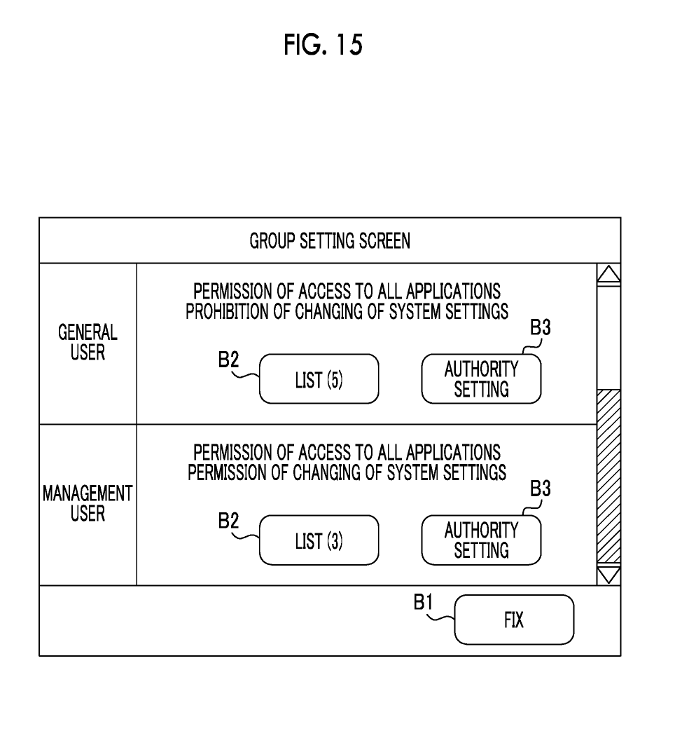

FIG. 15 illustrates an example of a displayed group setting screen. In the example illustrated in FIG. 15, the UI terminal 4 displays display fields of respective groups such as a “general user” and a “management user”, and a fix button B1 for fixing settings.

The UI terminal 4 displays an explanation of the authority of each group (for example, in a case of a general user, explanations of “permission of access to all applications” and “prohibition of changing of system settings”), a list button B2, and an authority setting button B3 are displayed in the display fields. If an operation of pressing the list button B2 is performed, a list of users belonging to the group is displayed, and then the UI terminal 4 enters a state of being capable of receiving addition and deletion from a user with respect to the list. If an operation of pressing the authority setting button B3 is performed, a screen for setting authority applied to the group is displayed.

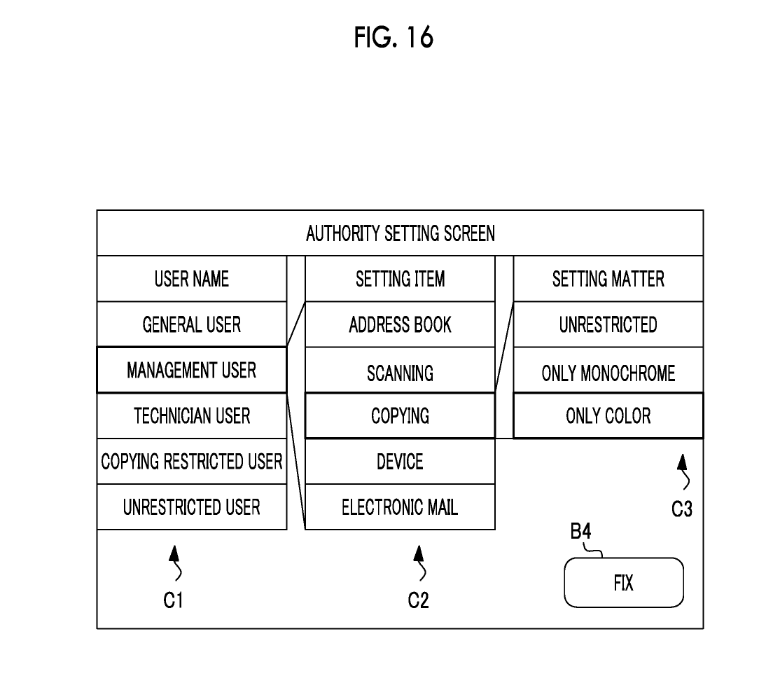

FIG. 16 illustrates an example of a displayed authority setting screen. In the example illustrated in FIG. 16, the UI terminal 4 displays a list C1 of group names, setting items C2 in a selected group from the list C1, a setting matter C3 of an item selected from the setting items C2, and a fix button B4 for fixing settings. In this example, “copying” is selected as a setting item of a “management user”, and a setting matter of “only color” is selected. If an operation of pressing the fix button B4 is performed in this state, in the above-described example, the management user has the authority for unrestricted copying, but is changed to have the authority for only color.

If the settings are changed on the group setting screen and the authority setting screen, and then an operation of pressing the fix button B1 illustrated in FIG. 15 is performed, the UI terminal 4 transmits change data indicating the content of the changed settings to the device layer 200, and the change data is received by the authority management part 703. The authority management part 703 updates the determination method data stored in the determination method data memory 705 on the basis of the content of the settings indicated by the received change data.

For example, in the above-described example, in a case where the user A included in a “management user” is changed to be also included in a “technician user”, the authority management part 703 reads the determination method data illustrated in FIG. 13 in which the user A is set as a target user, and updates the determination method data by correlating “G003” which is a group ID of the technician user and an authority ID indicating the authority applied to the technician user with the user ID of the user A.

In a case where a management user's authority for copying is changed from “unrestricted copying permission” to “only color copying permission”, the authority management part 703 reads all determination method data in which users included in the management user are set as target users, and changes “A001” which an authority ID of “unrestricted copying permission” correlated with “G002” which is a group ID of the management user to “A003” which an authority ID of “only color copying permission” so as to update the determination method data.

Hereinafter, a description will be made of an operation performed by the information processing system 1 until an operation image is displayed after a user logs in.

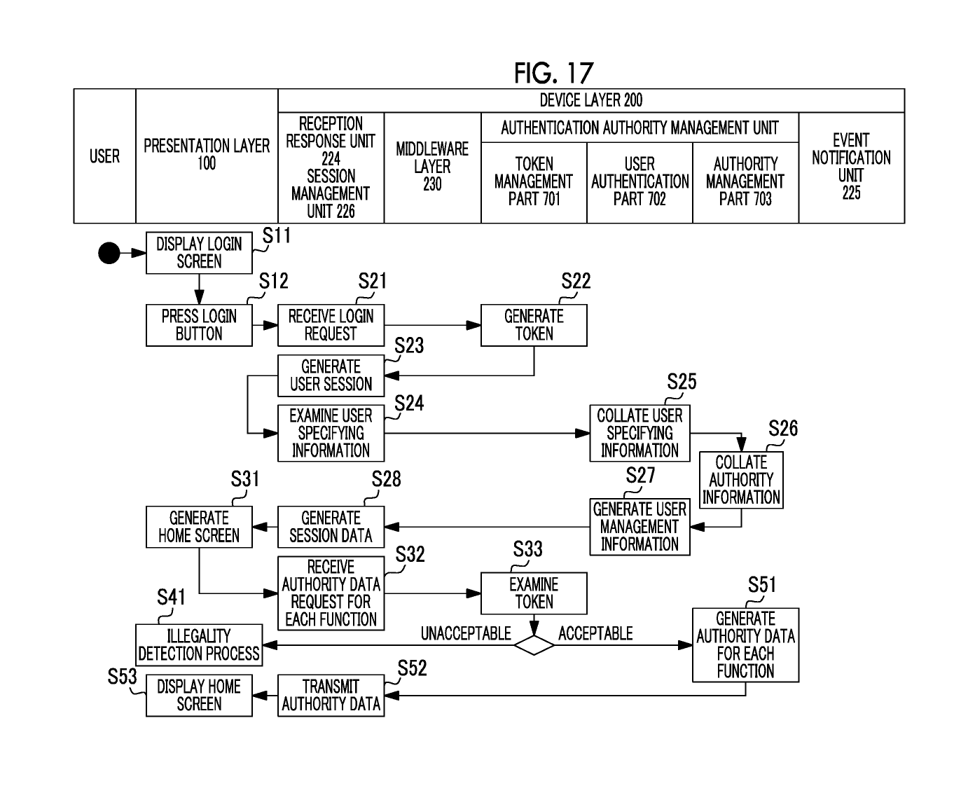

FIG. 17 illustrates examples of operation procedures in the information processing system 1. The operation illustrated in FIG. 17 is started, for example, when a user operates the UI terminal 4, and performs an operation of displaying a login screen. First, the presentation layer 100 displays a login screen (step S11). If the user enters a user ID and a password thereof on the login screen, and performs an operation of pressing a login button, the presentation layer 100 receives the operation (pressing of the login button), and transmits a login request (data including the user ID and the password and indicating a login request) to the device layer 200 (step S12).

Next, the reception response unit 224 receives the transmitted login request, and supplies the received login request to the token management part 701 (step S21). If the login request is supplied, the token management part 701 generates a token, and supplies the login request added with the generated token to the session management unit 226 (step S22). If the login request is supplied, the session management unit 226 generates a user session on the basis of the user ID indicated by the login request (step S23), and examines user specifying information (the user name illustrated in FIGS. 8 and 9 in the present example) included in the generated user session and then supplies the user specifying information to the user authentication part 702 along with the token (step S24).

The user authentication part 702 collates whether or not the user making the request for the login process is an authenticable user (step S25). In a case where the user is an authenticable user, the user authentication part 702 supplies the supplied user specifying information and token to the authority management part 703. The authority management part 703 collates whether or not the user specified by the supplied user specifying information has a permitted authority for the login process, and, if the user has the authority, the authority management part 703 notifies the user authentication part 702 of the fact (step S26).

The user authentication part 702 generates user management information indicating the supplied login request and authority data, and supplies the generated user management information to the reception response unit 224 along with the token (step S27). The reception response unit 224 generates session data on the basis of the supplied user management information, and transmits a session ID allocated to the generated session data to the presentation layer 100 as a response indicating that login is successful (step S28).

If the session ID is received, the presentation layer 100 determines that login is successful, and then generates a home screen (step S31). In this case, the presentation layer 100 transmits function information (information regarding a printing function, a scanning function, a copying function, and a FAX function) indicating functions displayed on the home screen and request data for making a request for authority data indicating the user's authorities for the functions, to the device layer 200 along with the session ID.

If the transmitted request data and session ID are received, the reception response unit 224 supplies the received request data to the token management part 701 along with session data allocated with the received session ID and the token supplied in step S22 (step S32). The token management part 701 examines whether or not a token is included in the supplied data, and the token is the token generated in step S22 (step S33), and, in a case where an examination result is not acceptable (in a case where the generated token is not included), the token management part 701 notifies the presentation layer 100 of the fact.

If the notification of not being acceptable is received, the presentation layer 100 performs an illegality detection process which is performed in a case where illegality is detected (step S41). The illegality detection process is a process in which, for example, text indicating that there is a possibility of an impersonation or a takeover of the user ID is displayed, and the display of the login screen is returned.

In a case where an examination result is acceptable (in a case where the generated token is included), the token management part 701 supplies the received request data and session data to the authority management part 703. The authority management part 703 generates authority data indicating an authority for each function indicated by the supplied request data on the basis of the supplied session data (step S51). Specifically, as described in FIGS. 13 and 14, the authority management part 703 acquires determination method data in which the user who logs in is set as a target user, determines a group to which the user belongs and an authority applied to the group, and generates authority data in which the determined group and authority are correlated with the user. The authority management part 703 supplies the generated authority data to the reception response unit 224.

The reception response unit 224 transmits the supplied authority data to the presentation layer 100 (step S52). If the authority data is received, the presentation layer 100 displays a home screen on the basis of the authority indicated by the authority data (step S53).

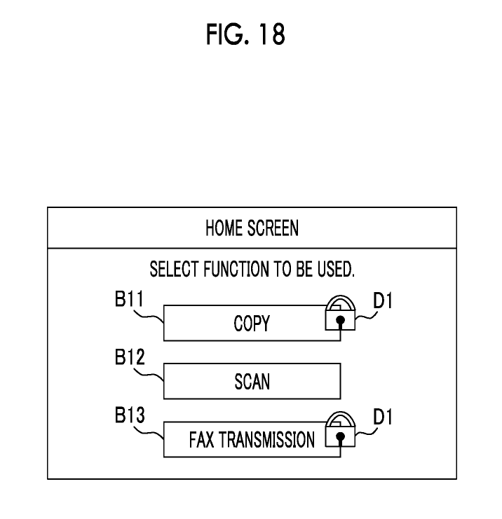

FIG. 18 illustrates an example of a home screen. In the example illustrated in FIG. 18, the presentation layer 100 displays the text that “please select a function to be used” on the home screen.

The presentation layer 100 displays a copy button B11, a scan button B12, and a FAX transmission button B13, and a lock image D1 indicating that there is a restriction is displayed for a function for which an authority indicated by the authority data is not unrestricted, that is, a function on which a certain restriction is imposed. In this example, the presentation layer 100 displays the lock images D1 to overlap the copy button B11 and the FAX transmission button B13. A restriction in a copying function is, for example, a restriction on available colors such as monochrome or colors. A restriction in a FAX transmission function is, for example, a restriction such as a transmission destination being restricted to a destination in a company or a domestic destination.

Next, a description will be made of an operation performed by the information processing system 1 in a case where a user makes a request for processing each function.

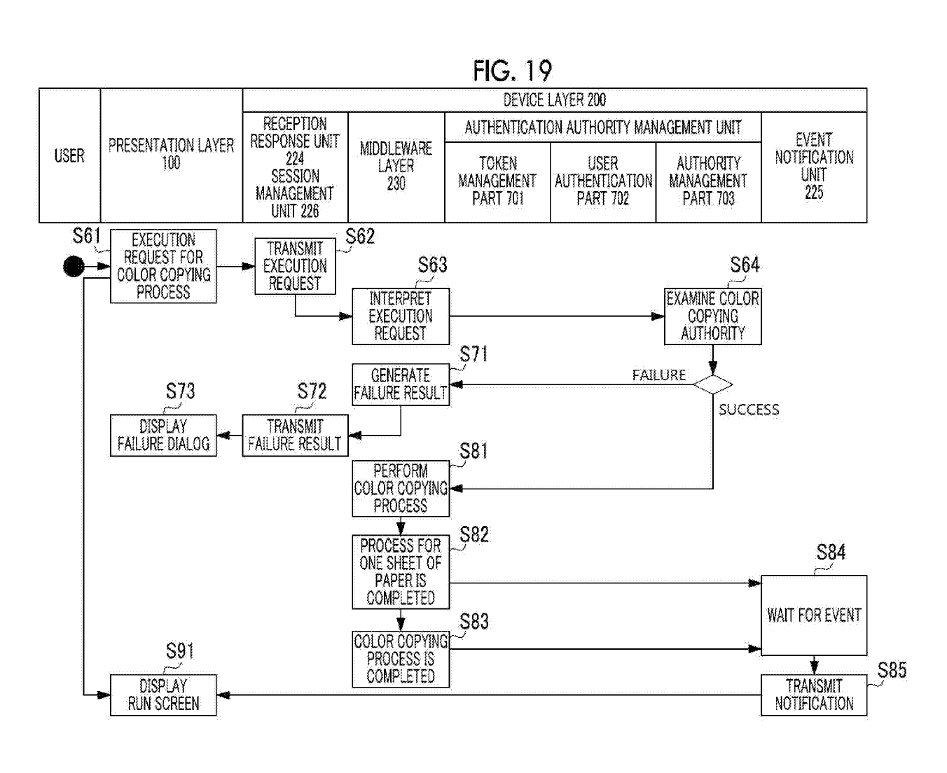

FIG. 19 illustrates examples of operation procedures in the information processing system 1. The operation illustrated in FIG. 19 is started, for example, when a user operates the UI terminal 4, and performs an operation of making a request for a color copying process.

First, the presentation layer 100 transmits an execution request for a color copying process (request data for making a request for performing a color copying process) to the device layer 200 (step S61). Next, the reception response unit 224 receives the transmitted execution request (step S62), and supplies the received execution request to the middleware layer 230. The middleware layer 230 interprets the supplied execution request as an execution request for the color copying process (step S63), and inquires of the authority management part 703 about whether or not the making the execution request has the authority for the color copying process.

The authority management part 703 examines whether or not the user has the authority for the color copying process by referring to authority data (for example, the authority data generated in step S51 in FIG. 17) generated for the user making the execution request (step S64). In a case where an examination result is not acceptable (in a case where the user does not have the authority for the color copying process =FAILURE), the authority management part 703 notifies the middleware layer 230 of the fact. If a notification of not being acceptable is received, the middleware layer 230 generates a failure result indicating that the execution request fails, and supplies the failure result to the reception response unit 224 (step S71).

The reception response unit 224 transmits the supplied failure result to the presentation layer 100 (step S72), and the presentation layer 100 displays a failure dialog indicating that the execution request fails on the basis of the received failure result (step S73). On the other hand, in a case where an examination result is acceptable (in a case where the user has the authority for the color copying process=SUCCESS), the authority management part 703 notifies the middleware layer 230 of the fact. If a notification of being acceptable is received, the middleware layer 230 performs the color copying process according to the received execution request (step S81).

If a color copying process for a sheet of paper is completed (step S82), the middleware layer 230 notifies the event notification unit 225 of the fact. The middleware layer 230 performs this notification when a color copying process for a sheet of paper is completed. If the whole color copying process is completed (step S83), the middleware layer 230 notifies the event notification unit 225 of the fact. The event notification unit 225 is maintained in a state of waiting for a notification of an event (step S84), and transmits a received notification to the presentation layer 100 when the notification is received from the middleware layer 230 (step S85).

The presentation layer 100 performs the execution request in step S61, and then displays a run screen (a screen representing the progress of a process) (step S91). The presentation layer 100 displays, for example, the number of copies on the run screen, displays an increased number of copies when receiving a notification indicating that a color copying process for a sheet of paper is completed from the event notification unit 225, and displays the text indicating that the whole color copying process is completed if a notification of the completion is performed.

The information processing apparatus 10 of the present example is an apparatus in which an authority is applied to each group to which users belong. In this apparatus, a method may be considered in which authorities are managed by using, for example, a table in which all users, groups to which the users belong, an authority applied to each group are correlated with each other. However, if the table is used for all of the users, for example, it is necessary to notify all of the users that updating of the table is to be performed, or that a process for which a request is made during the updating work is not completed and is required to be performed again. Therefore, labor costs are increased due to adjustment of the work time and the occurrence of downtime of the information processing apparatus, which in turn increases Total Cost of Ownership (TCO).

In the present example, even if a user's authority is changed, authority data indicating the changed authority is generated by updating determination method data in which the user is set as a target user. Thus, a partner notified of updating of authority data is only the target user, and, even if the above-described process is performed again, the influence thereof is restricted to the target user. As mentioned above, according to the present example, as in the information processing apparatus 10, in an apparatus in which an authority is applied to each group to which a user belongs, TCO is reduced compared with a case where an authority is managed by using a table for all users.

The information processing apparatus 10 of the present example includes the middleware layer 230 which is an example of a processing unit which performs a process responding to a request according to an authority indicated by authority data generated as described above. A processing unit corresponding to the middleware layer 230 may be provided in an external apparatus. In this case, the processing unit of the external apparatus is required to inquire of the information processing apparatus about an authority when a request for a process is made, and thus a communication load between both of the apparatuses tends to increase. In the present example, a communication load on the information processing apparatus is reduced compared with a case where an external apparatus includes a processing unit.

### 2. Modification Examples

The above-described Example is only an example in the invention, and may be modified as follows. The above-described Example and each modification example described below may be implemented through a combination thereof.

### 2-1. Request Transmission Source

In the Example, a user name is used as information regarding a transmission source, but this is only an example.

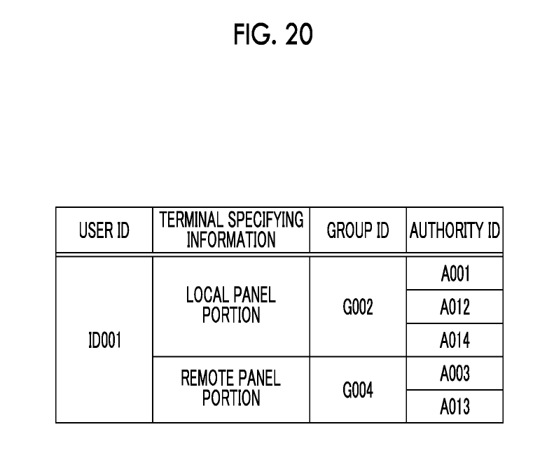

Information regarding a transmission source may be, for example, user specifying information such as a user ID other than a user name, and may be terminal specifying information for specifying the UI terminal 4 operated by a user. Both of user specifying information and terminal specifying information may be information regarding a transmission source, and, determination method data used in this case will be described with reference to FIG. 20.

FIG. 20 illustrates an example of determination method data of the present modification example. In the example illustrated in FIG. 20, the determination method data memory 705 stores a table, as determination method data, in which a user ID of “ID001” is correlated with terminal specifying information of a “local panel portion”, a group ID of “G002”, and authority IDs of “A001”, “A012”, and “A014”, and is also correlated with terminal specifying information of a “remote panel portion”, a group ID of “G004”, and authority IDs of “A003” and “A013”.

The determination method data indicates that, in a case where the user A having a user ID of “ID001” is set as a target user, if the user A makes a request for a process by using the UI terminal 4 functioning as a local panel portion, the user A is treated as being included in the management user group having a group ID of “G002”, and the user A has the authorities permitted for the management user. On the other hand, the determination method data indicates that, in a case where the user A makes a request for a process by using the UI terminal 4 functioning as a remote panel portion, the user A is treated as being included in the copying restricted group having a group ID of “G004”, and the user A has the authorities (in this example, the authorities of which authority IDs are “A003” and “A013”) permitted for the copying restricted user.

In a case where session data including the “user A” is acquired, the authority management part 703 reads terminal specifying information included in the session data, determines a group having a group ID correlated with the user ID of the user A and the read terminal specifying information as a group to which the user making the request for a process belongs, and determines an authority applied to the group as an authority of the user making the request for a process. Consequently, even the same user has different authorities depending on the type of UI terminal 4 (in this example, the local panel portion or the remote panel portion).

### 2-2. Exclusive Authority

Authorities managed by the authority management part 703 are not limited to the above description. For example, an authority not to permit a process for which other users make a request (that is, the process is not permitted to be performed) in a period in which a specific uses the information processing apparatus 10, that is, an authority for the specific user to exclusively use the information processing apparatus 10 may be used.

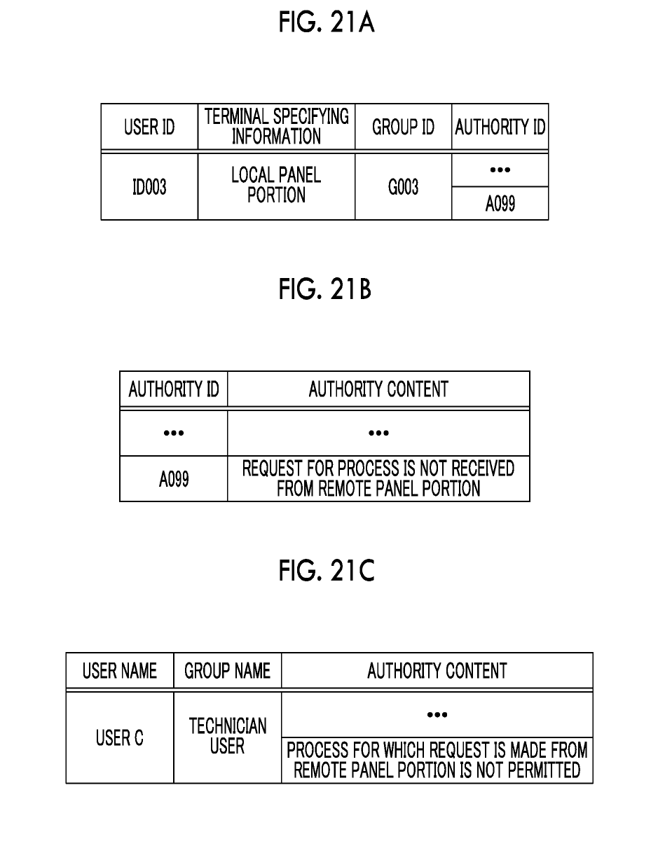

FIGS. 21A to 21C illustrate examples of determination method data of the present modification example. In the example illustrated in FIG. 21A, the determination method data memory 705 stores, as determination method data, a table in which a user ID (the user ID is assumed to be a user C) of “ID003” is correlated with terminal specifying information of a “local panel portion”, a group ID of the technician user group of “G003”, and an authority ID of “A099”.

The authority ID of “A099” is correlated with the authority content indicating an exclusive authority that “a process for which a request is made from a remote panel portion is not permitted” in an authority list as illustrated in FIG. 21B. Here, it is assumed that the information processing apparatus 10 is provided with only a single local panel portion. Thus, if the user C operates the local panel portion and is logging in, users other than the user C operate remote panel portions so as to make a request for a process. In other words, this authority indicates an exclusive authority not to permit a process for which a request is made from users other than the user C.

In the present modification example, if the user C operates the local panel portion, and logs in, the authority management part 703 acquires an authority list including the exclusive authority, generates authority data in which the user C, the technician user group, and the exclusive authority illustrated in FIG. 21B are correlated with, and stores the authority data in the authority data memory 706. In a case where a request for a process is made from the UI terminal 4, first, the middleware layer 230 determines whether or not there is authority data including an exclusive authority by referring to the authority data memory 706, and determines an authority so as to perform a process in the same manner as in each of the above-described examples in a case where it is determined that there is no authority data.

On the other hand, in a case where it is determined that there is authority data including an exclusive authority, that is, in a case where an authority list including the exclusive authority is generated by the authority management part 703, the middleware layer 230 determines whether or not the user making a request for a process is a specific user having the exclusive authority. In the examples illustrated in FIGS. 21, the middleware layer 230 determines that the user is a specific user having the exclusive authority in a case where the request for a process is made from a local panel portion, and determines that the user is not a specific user having the exclusive authority in a case where the request for a process is made from a remote panel portion.

In a case where it is determined that the user is not a specific user having the exclusive authority, the middleware layer 230 does not perform a process for which a request is made from users other than the specific user, and notifies the UI terminal 4 that the process for which the request is made is not permitted. In a case where it is determined that the user is a specific user having the exclusive authority, the middleware layer 230 performs the process for which the request is made from the specific user.

There are the following methods in addition to the above-described method as a method in which a request for a process from other users is unacceptable during a specific user' work as mentioned above. First, the information processing apparatus has a function in which the information processing apparatus operates in an exclusive authority mode so as to be exclusively used by a user who is currently performing work, and mode data indicating ON and OFF of the mode is stored in a predetermined region. The information processing apparatus determines whether or not there is an exclusive authority by referring to the stored mode data when a request for a process is made from a user.

In this method, when a request for a process is made from a user, the middleware layer 230 is required to refer to not only the authority data stored in the authority data memory 706 but also the mode data stored in another region. In the present modification example, data indicating an exclusive authority of a specific user (for example, a technician user) is stored as one of pieces of authority data in the authority data memory 706. Therefore, an exclusive authority is checked in the same operation as in checking of a user's authority.

### 2-3. Determination Method Data

Determination method data is not limited to the tables illustrated in FIGS. 13 and 20. For example, determination method data may be data obtained by representing the table illustrated in FIG. 13 by using a numerical expression such as “ID001″=”G002″=“A001”, “A012”, “A014”. In a case of this example, the authority management part 703 interprets the user ID, the group ID, and the authority IDs connected to each other with “=” as a relationship of being correlated with each other.

An algorithm in which a group ID and an authority ID are selected according to a value of a user ID by using the IF expression and the SWITCH expression of a program language may be used as determination method data. In this case, the authority management part 703 interprets, for example, the IF expression such as IF (user ID=ID001) then (group ID=G002) (authority ID=A001, A012, A014), as the user ID satisfying the conditional expression being correlated with the group ID and the authority IDs shown in the then statement. As mentioned above, determination method data may be expressed in any form as long as the data indicates a method of determining an authority applied to each user.

### 2-4. Functional Configuration Realizing Each Unit

In the above-described Example and modification examples, the reception response unit. 224 is an example of a reception unit of an exemplary embodiment of the invention, the authentication authority management unit 227 are examples of a first acquisition unit, a second acquisition unit, a third acquisition unit, a determination unit, and a generation unit of an exemplary embodiment of the invention, and the middleware layer 230 is an example of a processing unit of an exemplary embodiment of the invention, but these are only examples. For example, the function unit 223 may function as the processing unit, and the function unit 223, the authentication authority management unit 227, and the middleware layer 230 may function as the processing unit in cooperation with each other.

The communication unit 210 and the reception response unit 224 may function as a reception unit in cooperation with each other, and functions corresponding to the first acquisition unit, the second acquisition unit, the third acquisition unit, the determination unit, and the generation unit may be provided separately from each other. The session data memory 603, the list memory 704, the determination method data memory 705, and the authority data memory 706 may be provided in an external storage device. In other words, various storage locations of data are not limited to master apparatuses. In this case, the information processing apparatus may acquire data stored in each memory by referring to the external storage device.

### 2-5. Category of Invention

The invention may be understood as an information processing apparatus, an UI terminal, and an information processing system including the apparatuses. The invention may be understood as an information processing method for realizing a process performed by such an apparatus, and may be understood as a program for causing each computer such as the information processing apparatus and the user terminal to function as the above-described respective units. The program may be provided in the form of a recording medium such as an optical disc on which the program is stored, and may be provided in the form in which the program is downloaded to a computer via a communication line such as the Internet, and is installed in the computer so as to be available.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first acquisition unit that acquires a list of users, a list of a plurality of groups to which the users belong, and a list of a plurality of authorities defining whether or not a process is possible;
a second acquisition unit that acquires method data indicating a method of determining, with respect to a target user, a group to which the user belongs among the plurality of groups and an authority applied to the group among the plurality of authorities on the basis of associated information regarding the user;
a reception unit that receives a request for a process from a user, transmitted from a terminal;
a third acquisition unit that acquires transmission source data including information regarding the user or the terminal which is a transmission source of the request;
a determination unit that determines a group to which the user making the request belongs and an authority applied to the group among a plurality of groups and a plurality of authorities indicated by the acquired lists according to a method indicated by the acquired method data by using information included in the acquired transmission source data as the associated information; and
a generation unit that generates authority data in which the user making the request for a process is correlated with the determined authority.

2. The information processing apparatus according to claim 1, further comprising:
a processing unit that performs a process responding to the request according to an authority indicated by the generated authority data.

3. The information processing apparatus according to claim 2,
wherein the first acquisition unit acquires a list of the plurality of authorities including an exclusive authority not to permit a process for which users other than a specific user make a request, and
wherein, in a case where the authority data indicating the exclusive authority is generated, the processing unit performs a process for which a request is made from the specific user, and does not perform a process for which a request is made from users other than the specific user.

4. An information processing apparatus comprising:
a first acquisition means for acquiring a list of users, a list of a plurality of groups to which the users belong, and a list of a plurality of authorities defining whether or not a process is possible;
a second acquisition means for acquiring method data indicating a method of determining, with respect to a target user, a group to which the user belongs among the plurality of groups and an authority applied to the group among the plurality of authorities on the basis of associated information regarding the user;
a reception means for receiving a request for a process from a user, transmitted from a terminal;
a third acquisition means for acquiring transmission source data including information regarding the user or the terminal which is a transmission source of the request;
a determination means for determining a group to which the user making the request belongs and an authority applied to the group among a plurality of groups and a plurality of authorities indicated by the acquired lists according to a method indicated by the acquired method data by using information included in the acquired transmission source data as the associated information; and
a generation means for generating authority data in which the user making the request for a process is correlated with the determined authority.
